(19) United States
(12) Patent Application Publication
(10) Pub. No.: US 2024/0098006 A1
(43) Pub. Date: Mar. 21, 2024

(54) DETERMINATION OF ROUND TRIP TIMES BETWEEN DEVICES IN A PATH OF DEVICES

(71) Applicant: Charter Communications Operating, LLC, St. Louis, MO (US)

(72) Inventor: Patrick Phillip Hunter, St. Charles, MO (US)

(21) Appl. No.: 17/945,720

(22) Filed: Sep. 15, 2022

(51) Int. Cl. H04L 43/0864; H04L 43/062

(52) U.S. Cl. CPC H04L 43/0864; H04L 43/062

(57) ABSTRACT

A control message is generated by a source device, the control message including an indication that least one intermediate device in a path of devices between the source device and a destination device is to send a plurality of ICMP echo requests to a next device in the path of devices. The source device sends, to the at least one intermediate device, the control message. The source device receives, from the at least one intermediate device, a control message response originating from the destination device, the control message response comprising, for each respective intermediate device of the at least one intermediate device, round trip time information derived from a plurality of ICMP echo requests issued by the respective intermediate device to a corresponding next device in the path of devices.

### BACKGROUND

A packet communicated from a source device to a destination device may traverse any number of intermediate devices before reaching the destination device. It is sometimes necessary to determine where a problem exists in a path of such devices.

### SUMMARY

The embodiments disclosed herein implement a control message that causes each device in a path of devices between a source device and a destination device to issue ICMP echo requests to a next device in the path of devices. The ICMP echo reply messages made in response to the ICMP echo requests are consolidated and returned to the source device, and may be output to a destination. The embodiments can provide detailed round trip times (RTTs) between each device in the path of devices, facilitating a deeper understanding of which link(s) may be causing a problem between the source device and the destination device.

In one embodiment a method is disclosed. The method includes generating, by a source device, a control message, the control message comprising an indication that at least one intermediate device in a path of devices between the source device and a destination device is to send a plurality of ICMP echo requests to a next device in the path of devices. The method further includes sending, by the source device to the at least one intermediate device, the control message. The method further includes receiving, by the source device from the at least one intermediate device, a control message response originating from the destination device, the control message response comprising, for each respective intermediate device of the at least one intermediate device, round trip time information derived from a plurality of ICMP echo requests issued by the respective intermediate device to a corresponding next device in the path of devices.

In another embodiment a source device is disclosed. The source device includes a memory, and a processor device coupled to the memory. The processor device is configured to generate a control message, the control message comprising an indication that at least one intermediate device in a path of devices between the source device and a destination device is to send a plurality of ICMP echo requests to a next device in the path of devices. The processor device is further configured to send, to the at least one intermediate device, the control message. The processor device is configured to receive, from the at least one intermediate device, a control message response originating from the destination device, the control message response comprising, for each respective intermediate device of the at least one intermediate device, round trip time information derived from a plurality of ICMP echo requests issued by the respective intermediate device to a corresponding next device in the path of devices.

In another embodiment a non-transitory computer-readable storage medium is disclosed. The non-transitory computer-readable storage medium includes executable instructions to cause a processor device to generate a control message, the control message comprising an indication that at least one intermediate device in a path of devices between the source device and a destination device is to send a plurality of ICMP echo requests to a next device in the path of devices. The instructions further cause the processor device to send, to the at least one intermediate device, the control message. The instructions further cause the processor device to receive, from the at least one intermediate device, a control message response originating from the destination device, the control message response comprising, for each respective intermediate device of the at least one intermediate device, round trip time information derived from a plurality of ICMP echo requests issued by the respective intermediate device to a corresponding next device in the path of devices.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which round trip times between devices in a path of devices can be determined according to one embodiment;

FIG. 2 is a block diagram illustrating a visualization of round trip times determined between devices in a path of devices according to one embodiment;

FIG. 3 is a flowchart of a method for determining round trip times between devices in a path of devices according to the embodiment illustrated in FIG. 1;

FIG. 4 is a block diagram of an environment in which round trip times between devices in a path of devices can be determined according to another embodiment;

FIG. 5 is a block diagram of an environment in which round trip times between devices in a path of devices can be determined according to another embodiment; and

FIG. 6 is a flowchart of a method for determining round trip times between devices in a path of devices according to another embodiment.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

A packet communicated from a source device on one network to a destination device on another network typically traverses a plurality of “links” from the source device to the destination device. A link refers to both a communications medium and a device at the end of the communications medium. Many operating systems implement a “ping” command that utilizes an Internet Control Message Protocol (ICMP) echo request and echo reply message to determine whether a destination device is reachable from a source device. The ping command also often returns a round trip time (RTT) of a packet communicated between the source device and the destination device. If either a communications medium in the path of devices is inoperable (e.g., a cable is severed), or a device in the path of devices is inoperable (e.g., a router is unresponsive), there will be no response to the ping command, and the operator who issued the ping command will not know if there are one or multiple inoperable links in the path, or which link or links are inoperable.

A traceroute command is implemented by various operating systems that sends a series of messages to devices in a path of devices from a source device to a destination device by increasing a time to live (TTL) value for each successive message. The traceroute command can determine which device is inoperable and is helpful where a particular link is consistently a problem. But where there is an intermittent impairment with a link, traceroute is not entirely reliable.

The embodiments disclosed herein implement a control message that causes each device in a path of devices between a source device and a destination device to issue ICMP echo requests to a next device in the path of devices. The ICMP echo reply messages made in response to the ICMP echo requests are consolidated and returned to the source device, and may be output to a destination. The embodiments can provide detailed RTTs of packets between each device in the path of devices, facilitating a deeper understanding of which link(s) may be causing a problem between the source device and the destination device.

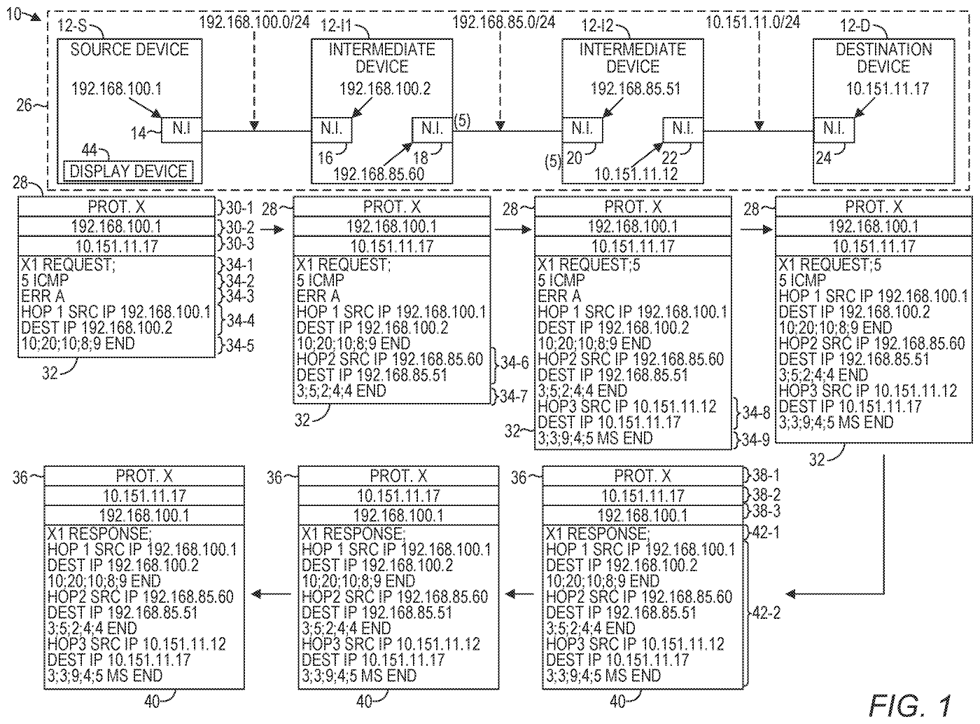

FIG. 1 is a block diagram of an environment 10 according to one embodiment. The environment 10 incudes a source device 12-S, a destination device 12-D, and a plurality of intermediate devices 12-I1-12-I2 (generally, devices 12). While not illustrated due to space limitations, each of the devices 12 include a processor device and a memory. The source device 12-S has a network interface 14 that has an IP address of 192.168.100.1 and utilizes a subnet mask of 255.255.255.0 and is thus on an IP network 192.168.100.0. The intermediate device 12-I1 has a network interface 16 that is communicatively coupled to the network interface 14 of the source device 12-S and has an IP address of 192.168.100.2 and utilizes a subnet mask of 255.255.255.0 and is thus also on the IP network 192.168.100.0. The intermediate device 12-I1 has a network interface 18 that has an IP address of 192.168.85.60 and utilizes a subnet mask of 255.255.255.0 and is thus on a network 192.168.85.0.

The intermediate device 12-I2 has a network interface 20 that is communicatively coupled to the network interface 18 of the intermediate device 12-I1 and has an IP address of 192.168.85.51 and utilizes a subnet mask of 255.255.255.0 and is thus also on the network 192.168.85.0. The intermediate device 12-I2 has a network interface 22 that has an IP address of 10.151.11.12 and utilizes a subnet mask of 255.255.255.0 and is thus on a network 10.151.11.0. The destination device 12-D has a network interface 24 that is communicatively coupled to the network interface 22 of the intermediate device 12-I2 and has an IP address of 10.151.11.17 and utilizes a subnet mask of 255.255.255.0 and is thus on a network 10.151.11.0. It is noted that while, for purposes of illustration only two intermediate devices 12-I1-12-I2 are illustrated, in practice, there may be any number of intermediate devices between the source device 12-S and the destination device 12-D.

The intermediate devices 12-I1 and 12-I2 are in a path 26 of devices from the source device 12-S to the destination device 12-D based on addressing information maintained in the source device 12-S and the intermediate devices 12-I1 and 12-I2. In particular, the intermediate device 12-I1 may be designated as a default gateway router for the source device 12-S, and the intermediate device 12-I1 may contain a routing table that identifies the intermediate device 12-I2 as the next device (e.g., the next hop device) for a packet that is destined for the destination device 12-D.

With respect to a packet being transmitted from the source device 12-S toward the destination device 12-D (e.g., identifies an IP address of the destination device 12-D), each device 12 in the path 26 of devices 12 is a next device 12 in the path 26 of devices 12 with respect to the previous device 12 in the path 26 of devices 12. For example, the intermediate device 12-I1 is the next device 12 in the path 26 of devices 12 from the perspective of the source device 12-S, the intermediate device 12-I2 is the next device 12 in the path 26 of devices 12 from the perspective of the intermediate device 12-I1, and the destination device 12-D is the next device 12 in the path 26 of devices 12 from the perspective of the intermediate device 12-I2.

With this background, determination of round trip times between devices in the path 26 of devices according to one embodiment will now be discussed. The source device 12-S receives an input command. The input command can follow any desired syntax. The input command contains information that identifies the destination device 12-D as the destination device, and contains information that indicates that the source device 12-S is to generate a type X1 “PROT. X” control message. Optionally, the input command may identify a quantity of ICMP echo requests to be sent by each device 12, and a particular type of error handling, both of which may be included in the type X1 “PROT. X” control message. In response to the input command, the source device 12-S generates a control message 28. In this example, the control message 28 is a packet that contains a control message identifier field 30-1 that identifies the packet as a “PROT. X” control message. Network software contained in each of the intermediate devices 12-I1 and 12-I2, and the destination device 12-D, have been designed to function in the manner described herein upon receipt of a packet that has a control message identifier field 30-1 with the value of “PROT. X”.

The source device 12-S generates the control message 28 such that a source address field 30-2 identifies the source device 12-S as the originator of the control message 28 and a destination address field 30-3 identifies the destination device 12-D as the destination of the control message 28. In some embodiments, the control message 28 may comprise an IP packet, and a bit or field of a standard IP packet may be utilized to indicate that the IP packet is a “PROT. X” control message that should be processed in the manner described herein.

In this embodiment, the source device 12-S may generate the control message 28 to have a payload 32 that includes information 34-1 that indicates that the control message 28 is a particular type of protocol X control message, in particular an X1 type protocol X control message (e.g., “X1 REQUEST”). The payload 32 also includes ICMP echo request quantity 34-2 that indicates that each device 12 in the path 26 of devices 12 is to send 5 ICMP echo requests to the next device 12 in the path 26 of devices 12 (e.g., “5 ICMP”). The payload 32 also includes information 34-3 that indicates what actions a device 12 in the path 26 of devices 12 should take in the event of an error (“ERR A”). Error handling will be discussed in greater detail below.

The source device 12-S may initially send five ICMP echo requests to the intermediate device 12-I1 and receive, in response, five ICMP echo reply messages from the intermediate device 12-I1. The source device 12-S determines that the round-trip times (RTTs) of the five ICMP echo requests and five ICMP echo reply messages were 10, 20, 10, 8 and 9. The source device 12-S includes in the payload 32 information 34-4 that includes device identifiers that identify the two devices between which the RTTs were determined (i.e., the source device 12-S and the intermediate device 12-I1), and information 34-5 that identifies the five RTTs. The source device 12-S then sends the control message 28 toward the destination device 12-D by sending the control message 28 to the intermediate device 12-I1 according to the network information maintained by the source device 12-S. In this example, the network information may be a subnet mask that indicates that the destination device 12-D is on a different network from the source device 12-S, and information that identifies the intermediate device 12-I1 as the default gateway via which messages can be sent to destinations that are on different networks from the source device 12-S.

The intermediate device 12-I1 receives the control message 28 and recognizes, based on the control message identifier field 30-1 that the control message 28 is a “PROT. X” control message. The intermediate device 12-I1 accesses the payload 32 and determines, based on the information 34-1 that the control message 28 is an X1 type protocol X control message (e.g., “X1 REQUEST”). The intermediate device 12-I1 accesses the ICMP echo request quantity 34-2 and determines that 5 ICMP echo requests are to be sent to the next device 12 in the path 26 of devices 12. The intermediate device 12-I1 determines, based on layer 3 information maintained by the intermediate device 12-I1, that the intermediate device 12-I2 is the next device (e.g., the next hop) to which a message destined for the IP address identified in the destination address field 30-3 (10.151.11.17) is to be sent.

The intermediate device 12-I1 sends five ICMP echo requests to the intermediate device 12-I2 and receives, in response, five ICMP echo reply messages from the intermediate device 12-I2. The intermediate device 12-I1 determines that the round-trip times (RTTs) of the five ICMP echo requests and corresponding five ICMP echo reply messages are 3, 5, 2, 4 and 4. The intermediate device 12-I1 modifies the payload 32 to include information 34-6 that includes device identifiers, such as IP addresses, that identify the two devices between which the RTTs were determined (i.e., the intermediate device 12-I1 and the intermediate device 12-I2), and information 34-7 that identifies the five RTTs. The intermediate device 12-I1 then sends the control message 28 toward the destination device 12-D by sending the control message 28 to the intermediate device 12-I2.

The intermediate device 12-I2 receives the control message 28 and recognizes, based on the control message identifier field 30-1 that the control message 28 is a “PROT. X” control message. The intermediate device 12-I2 accesses the payload 32 and determines, based on the information 34-1 that the control message 28 is an X1 type protocol X control message (e.g., “X1 REQUEST”). The intermediate device 12-I2 accesses the ICMP echo request quantity 34-2 and determines that 5 ICMP echo requests are to be sent to the next device 12 in the path 26 of devices 12. The intermediate device 12-I2 determines that the destination device 12-D is on the same network as the intermediate device 12-I2 (via the network interface 22), and thus that the destination device 12-D is the next device 12 in the path 26 of devices 12. The intermediate device 12-I2 sends five ICMP echo requests to the destination device 12-D and receives, in response, five ICMP echo reply messages from the destination device 12-D. The intermediate device 12-I2 determines that the round-trip times (RTTs) of the five ICMP echo requests and corresponding five ICMP echo reply messages are 3, 3, 9, 4 and 5. The intermediate device 12-I2 modifies the payload 32 to include information 34-8 that includes device identifiers, such as IP addresses of the two devices, between which the RTTs were determined (i.e., the intermediate device 12-I2 and the destination device 12-D), and information 34-9 that identifies the five RTTs. The intermediate device 12-I2 then sends the control message 28 to the destination device 12-D via the network interface 22.

The destination device 12-D receives the control message 28 and recognizes, based on the control message identifier field 30-1 that the control message 28 is a “PROT. X” control message. The destination device 12-D accesses the payload 32 and determines, based on the information 34-1 that the control message 28 is an X1 type protocol X control message (e.g., “X1 REQUEST”). The destination device 12-D accesses the destination address field 30-3 and determines that the control message 28 was addressed to the destination device 12-D.

The destination device 12-D generates a control message response 36. The control message response 36 includes a control message identifier field 38-1 that identifies the packet as a “PROT. X” control message. The control message response 36 has a source address field 38-2 that identifies the destination device 12-D as the originator of the control message response 36 and a destination address field 38-3 that identifies the source device 12-S as the destination of the control message response 36. The destination device 12-D generates a payload 40 that includes information 42-1 that identifies the control message response 36 as a control message response. The destination device 12-D includes in the payload 40 information 42-2 copied from the control message 28 regarding the RTTs and IP addresses generated by the source device 12-S and intermediate devices 12-I1 and 12-I2. The destination device 12-D sends the control message response 36 toward the source device 12-S by sending the control message response 36 to the intermediate device 12-I2 according to the network information maintained by the destination device 12-D.

The intermediate device 12-I2 receives the control message response 36 from the destination device 12-D and determines, based on the control message identifier field 38-1 and the information 42-1 that the control message response 36 is a control message response to the previously sent control message 28. Based on the destination address field 38-3, the intermediate device 12-I2 determines that the control message response 36 is destined for the source device 12-S. Based on network information maintained by the intermediate device 12-I2, the intermediate device 12-I2 determines that the intermediate device 12-I1 is the next device in a path of devices between the intermediate device 12-I2 and the source device 12-S, and sends the control message response 36 to the intermediate device 12-I1.

The intermediate device 12-I1 receives the control message response 36 from the intermediate device 12-I2 and determines, based on the control message identifier field 38-1 and the information 42-1 that the control message response 36 is a control message response to the previously sent control message 28. Based on the destination address field 38-3, the intermediate device 12-I1 determines that the control message response 36 is destined for the source device 12-S. Based on network information maintained by the intermediate device 12-I1, the intermediate device 12-I1 determines that the intermediate device 12-I1 can send the control message response 36 directly to the source device 12-S via the network interface 16. The intermediate device 12-I1 sends the control message response 36 directly to the source device 12-S.

The source device 12-S receives the control message response 36 and may present the information contained in the payload 40 on a display device 44 of the source device 12-S.

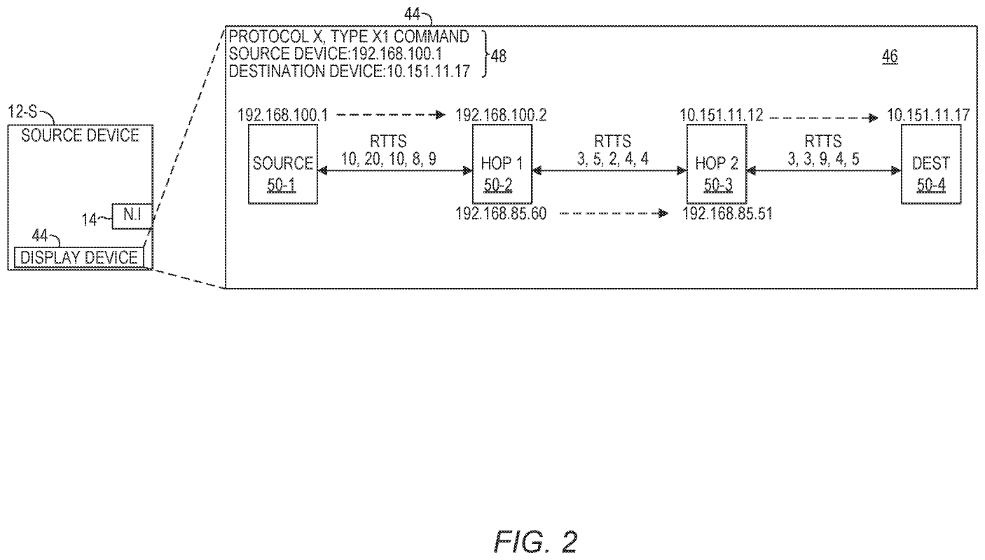

FIG. 2 is a block diagram illustrating a visualization of information associated with round trip times determined between devices in a path of devices according to one embodiment. In this embodiment, the source device 12-S receives the control message response 36 as illustrated in FIG. 1. The source device 12-S, based on the control message response 36, generates and presents on the display device 44 imagery 46 that contains information 48 that identifies the type of protocol X command that was issued, the source device, and the destination device. The imagery 46 also includes symbols 50-1-50-4 that correspond to each of the devices in the path 26 of devices. The imagery 46 may also identify the IP addresses of each of the network interfaces of such devices, as well as the RTTs determined between each of the devices in the path 26 of devices. In this example, the actual RTTs are presented. In other examples, in lieu of or in addition to the actual RTTs, the imagery 46 may present an average RTT between the devices, a mean RTT between the devices, and/or a mode of the RTTs between the devices. It is to be noted that FIG. 2 illustrates only an example embodiment, and in other embodiments, RTT information may be presented in a wholly text-based format.

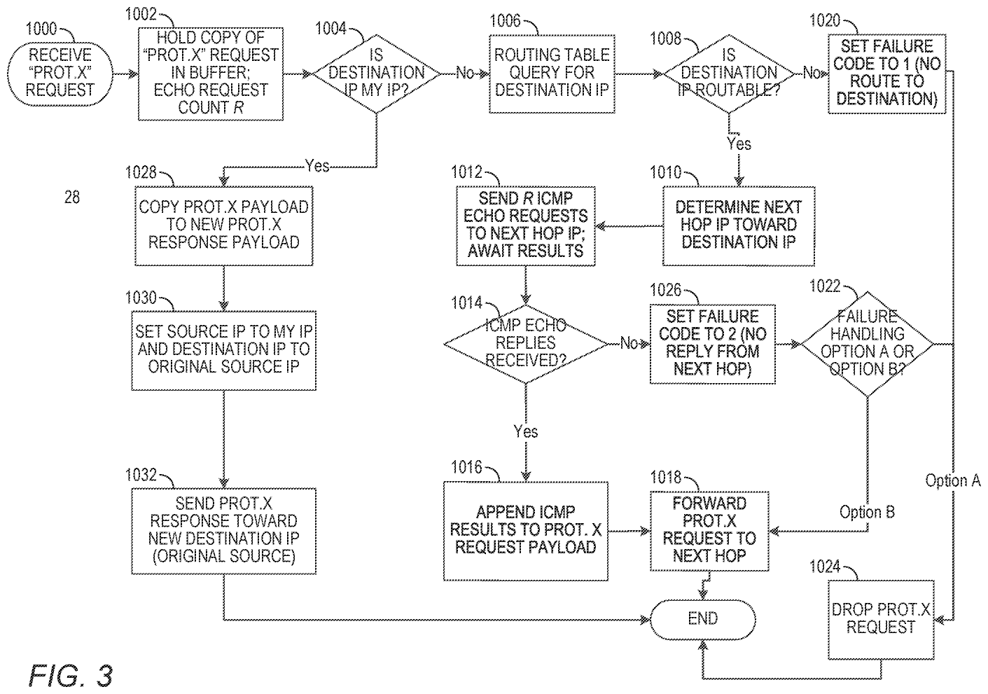

FIG. 3 is a flowchart of a method for determining round trip times between devices in the path 26 of devices 12 according to the embodiment illustrated in FIG. 1. Assume for purposes of illustration that the source device 12-S has created the control message 28 as described above and sent the control message 28 to the intermediate device 12-I1. The intermediate device 12-I1 receives the control message 28 (block 1000). The intermediate device 12-I1 stores the control message 28 in a buffer (block 1002). The intermediate device 12-I1 accesses the destination address field 30-3 to determine whether the IP address of the intermediate device 12-I1 is the destination IP address (block 1004). In this example, the IP address of the intermediate device 12-I1 is not the destination IP address, and at block 1006 the intermediate device 12-I1 accesses the routing table of the intermediate device 12-I1 to determine the next hop (i.e., the next device 12). If at block 1008 it is determined that the destination is routable, then at block 1010 the intermediate device 12-I1 determines that the intermediate device 12-I2 is the next device 12 in the path 26 of devices 12. At block 1012, the intermediate device 12-I1 sends five ICMP requests to the intermediate device 12-I2. If, at block 1014, the intermediate device 12-I1 receives ICMP echo reply messages, then at block 1016 the intermediate device 12-I1 appends the ICMP results (e.g., RTTs) to the payload 32. At block 1018 the intermediate device 12-I1 sends the control message 28 to the intermediate device 12-I2. The intermediate device 12-I2 then repeats the steps described herein with regard to the intermediate device 12-I1.

If at block 1008 it was determined that the destination is unrouteable, at block 1020 the payload 32 may be modified to a failure code 1 (no route to destination), and the packet (i.e., the control message 28) may be dropped at block 1024. If at block 1014 the intermediate device 12-I1 does not receive ICMP echo reply responses from the intermediate device 12-I2, at block 1026 the intermediate device 12-I1 modifies the payload 32 to indicate a failure code 2 (no reply from next hop). At block 1022, it is determined if the failure handling is option A or option B. If option A, the intermediate device 12-I1 drops the packet at 1024. If option B, the intermediate device 12-I1 forwards the packet to the intermediate device 12-I2.

When the destination device 12-D receives the control message 28, then at block 1004, the destination device 12-D determines that the IP address of the destination device 12-D is the destination IP address. At block 1028, the destination device 12-D generates the control message response 36 and copies the payload 32 of the control message 28 to the payload 40 of the control message response 36. At block 1030, the destination device 12-D sets the source address field 38-2 to the IP address of the destination device 12-D and the destination address field 38-3 to the IP address of the source device 12-S. At block 1032 the destination device 12-D sends the control message response 36 toward the source device 12-S (via the intermediate device 12-I2).

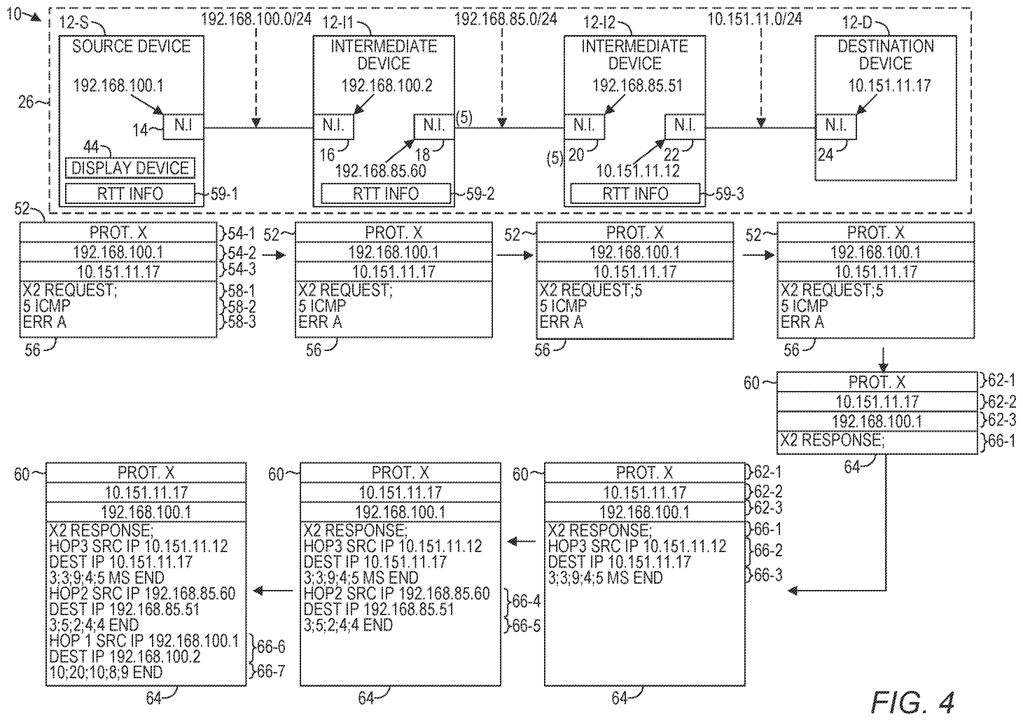

FIG. 4 is a block diagram of the environment 10 in which round trip times between devices in a path of devices can be determined according to another embodiment. In this embodiment, the source device 12-S receives an input command that contains information that identifies the destination device 12-D as the destination device, and contains information that indicates that the command is a type X2 “PROT. X” command. As will be discussed below, a type X2 “PROT. X” command differs from a type X1 “PROT. X” command in that the control message is sent to the next device 12 in the path 26 of devices 12 independent of the sending of ICMP echo requests to the next device 12 in the path 26 of devices 12. The RTTs determined by the ICMP echo requests and the corresponding ICMP echo reply messages are then inserted by each device 12 in the path 26 of devices 12 into the control message response. This allows the determination of RTTs along the path 26 of devices at substantially a same instant in time.

In response to the input command, the source device 12-S generates a control message 52. In this example, the control message 28 is a packet that contains a control message identifier field 54-1 that identifies the packet as a “PROT. X” control message. Network software contained in each of the intermediate devices 12-I1 and 12-I2, and the destination device 12-D, have been designed to function in the manner described herein upon receipt of a packet that has a control message identifier field 54-1 with the value of “PROT. X”.

The source device 12-S generates the control message 52 such that a source address field 54-2 identifies the source device 12-S as the originator of the control message 28 and a destination address field 54-3 identifies the destination device 12-D as the destination of the control message 52. In some embodiments, the control message 52 may comprise an IP packet, and a bit or field of a standard IP packet may be utilized to indicate that the IP packet is a “PROT. X” control message that should be processed in the manner described herein.

The source device 12-S generates the control message 52 to have a payload 56 that includes information 58-1 that indicates that the control message 52 is a particular type of protocol X control message, in particular an X2 type protocol X control message (e.g., “X2 REQUEST”). The payload 56 also includes ICMP echo request quantity 58-2 that indicates that each device 12 in the path 26 of devices 12 is to send 5 ICMP echo requests to the next device 12 in the path 26 of devices 12 (e.g., “5 ICMP”). The payload 56 also includes information 58-3 that indicates what actions a device 12 in the path 26 of devices 12 should take in the event of an error (“ERR A”).

The source device 12-S then sends the control message 52 toward the destination device 12-D by sending the control message 52 to the intermediate device 12-I1 according to the network information maintained by the source device 12-S. The source device 12-S may then send five ICMP echo requests to the intermediate device 12-I1 and receive, in response, five ICMP echo reply messages from the intermediate device 12-I1. The source device 12-S determines that the round-trip times (RTTs) of the five ICMP echo requests and five ICMP echo reply messages were 10, 20, 10, 8 and 9, and stores the RTTs and the IP addresses of the source device 12-S and the intermediate device 12-I1 as RTT information 59-1.

The intermediate device 12-I1 receives the control message 52 and recognizes, based on the control message identifier field 54-1 that the control message 52 is a “PROT. X” control message. The intermediate device 12-I1 accesses the payload 56 and determines, based on the information 58-1 that the control message 52 is an X2 type protocol X control message (e.g., “X2 REQUEST”). The intermediate device 12-I1 accesses the ICMP echo request quantity 58-2 and determines that 5 ICMP echo requests are to be sent to the next device 12 in the path 26 of devices 12. The intermediate device 12-I1 determines, based on layer 3 information maintained by the intermediate device 12-I1, that the intermediate device 12-I2 is the next device (e.g., the next hop) to which a message destined for the IP address identified in the destination address field 30-3 (10.151.11.17) is to be sent.

The intermediate device 12-I1 then sends the control message 52 toward the destination device 12-D by sending the control message 52 to the intermediate device 12-I2 according to the network information maintained by the intermediate device 12-I1. The intermediate device 12-I1 may then send five ICMP echo requests to the intermediate device 12-I2 and receive, in response, five ICMP echo reply messages from the intermediate device 12-I2. The intermediate device 12-I1 determines that the round-trip times (RTTs) of the five ICMP echo requests and five ICMP echo reply messages were 3, 5, 2, 4 and 4, and stores the RTTs and the IP addresses of the intermediate device 12-I1 and the intermediate device 12-I2 as RTT information 59-2.

The intermediate device 12-I2 receives the control message 52 and recognizes, based on the control message identifier field 541-1 that the control message 52 is a “PROT. X” control message. The intermediate device 12-I2 accesses the payload 56 and determines, based on the information 58-1 that the control message 52 is an X2 type protocol X control message (e.g., “X2 REQUEST”). The intermediate device 12-I2 accesses the ICMP echo request quantity 58-2 and determines that 5 ICMP echo requests are to be sent to the next device 12 in the path 26 of devices 12. The intermediate device 12-I2 determines that the destination device 12-D is on the same network as the intermediate device 12-I2 (via the network interface 22), and thus that the destination device 12-D is the next device 12 in the path 26 of devices 12. The intermediate device 12-I2 then sends the control message 52 to the destination device 12-D via the network interface 22. The intermediate device 12-I2 sends five ICMP echo requests to the destination device 12-D and receives, in response, five ICMP echo reply messages from the destination device 12-D. The intermediate device 12-I2 determines that the round-trip times (RTTs) of the five ICMP echo requests and corresponding five ICMP echo reply messages are 3, 3, 9, 4 and 5 and stores the RTTs and the IP addresses of the intermediate device 12-I2 and the destination device 12-D as RTT information 59-3.

The destination device 12-D receives the control message 52 and recognizes, based on the control message identifier field 54-1 that the control message 52 is a “PROT. X” control message. The destination device 12-D accesses the payload 56 and determines, based on the information 58-1 that the control message 52 is an X2 type protocol X control message (e.g., “X2 REQUEST”). The destination device 12-D accesses the destination address field 54-3 and determines that the control message 52 was addressed to the destination device 12-D.

The destination device 12-D waits a predetermined amount of time, such as 250 milliseconds (ms), 500 ms, a second, or the like, and then generates a control message response 60, or, alternatively, generates the control message response 60 and waits the predetermined amount of time. The control message response 60 includes a control message identifier field 62-1 that identifies the packet as a “PROT. X” control message. The control message response 60 has a source address field 62-2 that identifies the destination device 12-D as the originator of the control message response 60 and a destination address field 62-3 that identifies the source device 12-S as the destination of the control message response 60. The destination device 12-D generates a payload 64 that includes information 66-1 that identifies the control message response 60 as a X2 type control message response.

The destination device 12-D sends the control message response 60 toward the source device 12-S by sending the control message response 60 to the intermediate device 12-I2 according to the network information maintained by the destination device 12-D. The intermediate device 12-I2 receives the control message response 60 from the destination device 12-D and determines, based on the control message identifier field 62-1 and the information 66-1 that the control message response 60 is a control message response to the previously sent control message 52. The intermediate device 12-I2 determines, based on the information 66-1, that the control message response 60 is an X2 type control message response. The intermediate device 12-I2 accesses the previously stored RTT information 59-3 and modifies the payload 64 to include information 66-2 that identifies the IP addresses of the two devices between which the RTTs were determined (i.e., the intermediate device 12-I2 and the destination device 12-D), and information 66-3 that identifies the five RTTs.

In some embodiments, the intermediate device 12-I2 may maintain source and destination device information in conjunction with RTT information for any number of different control messages that may be relatively concurrently sent. Upon receipt of a control message response, the intermediate device 12-I2 determines whether the source device and destination device identified in the control message response matches those stored in conjunction with a previously stored RTT information, and if so, modifies the payload of the control message response to include such previously stored RTT information.

Based on the destination address field 62-3, the intermediate device 12-I2 determines that the control message response 60 is destined for the source device 12-S. Based on network information maintained by the intermediate device 12-I2, the intermediate device 12-I2 determines that the intermediate device 12-I1 is the next device in a path of devices between the intermediate device 12-I2 and the source device 12-S and sends the control message response 60 to the intermediate device 12-I1.

The intermediate device 12-I1 receives the control message response 60 from the intermediate device 12-I2 and determines, based on the control message identifier field 62-1 and the information 66-1 that the control message response 60 is a control message response to the previously sent control message 52. The intermediate device 12-I1 determines, based on the information 66-1, that the control message response 60 is an X2 type control message response. The intermediate device 12-I1 accesses the previously stored RTT information 59-2 and modifies the payload 64 to include information 66-4 that identifies the IP addresses of the two devices between which the RTTs were determined (i.e., the intermediate device 12-I1 and the intermediate device 12-I2), and information 66-5 that identifies the five RTTs. Based on the destination address field 62-3, the intermediate device 12-I1 determines that the control message response 60 is destined for the source device 12-S. Based on network information maintained by the intermediate device 12-I1, the intermediate device 12-I1 determines that the intermediate device 12-I1 can send the control message response 60 directly to the source device 12-S. The intermediate device 12-I1 sends the control message response 60 directly to the source device 12-S.

The source device 12-S receives the control message response 60 from the intermediate device 12-I1 and determines, based on the control message identifier field 62-1 and the information 66-1 that the control message response 60 is a control message response to the previously sent control message 52. The source device 12-S determines, based on the information 66-1, that the control message response 60 is an X2 type control message response. The source device 12-S accesses the previously stored RTT information 59-1 that identifies the IP addresses of the two devices between which the RTTs were determined (i.e., the source device 12-S and the intermediate device 12-I1), and the five RTTs. The source device 12-S may then store such information as information 66-6 and 66-7 in the payload 64, and/or present the information contained in the payload 64 along with the previously stored RTT information 59-1 on the display device 44 in a manner similar that illustrated above with regard to FIG. 2.

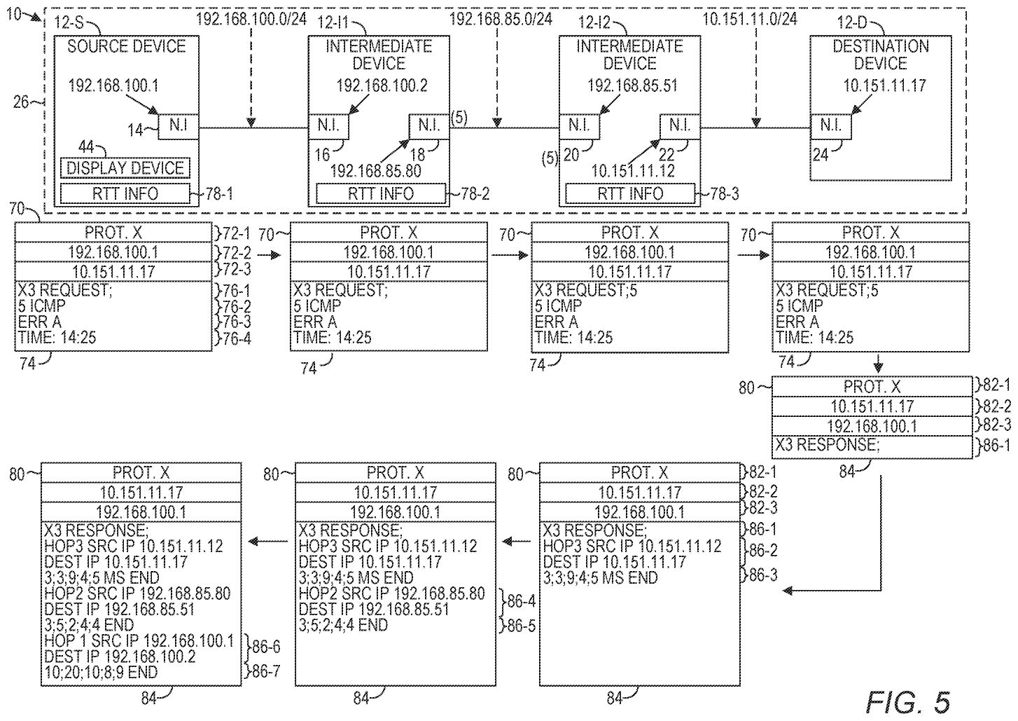

FIG. 5 is a block diagram of the environment 10 in which round trip times between devices 12 in the path 26 of devices 12 can be determined according to another embodiment. This embodiment is similar to the embodiment discussed in FIG. 4. In this embodiment the source device 12-S receives an input command that contains information that identifies the destination device 12-D as the destination device, and contains information that indicates that the command is a type X3 “PROT. X” command. The type X3 “PROT. X” command is similar to the type X2 “PROT. X” command except that each of the devices sends ICMP echo requests to the next device at the same point in time.

In this example, the source device 12 generates a control message 70 that contains a control message identifier field 72-1 that identifies the packet as a “PROT. X” control message. Network software contained in each of the intermediate devices 12-I1 and 12-I2, and the destination device 12-D, have been designed to function in the manner described herein upon receipt of a packet that has a control message identifier field 72-1 with the value of “PROT. X”.

The source device 12-S generates the control message 70 such that a source address field 72-2 identifies the source device 12-S as the originator of the control message 28 and a destination address field 72-3 identifies the destination device 12-D as the destination of the control message 70. In some embodiments, the control message 70 may comprise an IP packet, and a bit or field of a standard IP packet may be utilized to indicate that the IP packet is a “PROT. X” control message that should be processed in the manner described herein.

The source device 12-S generates the control message 70 to have a payload 74 that includes information 76-1 that indicates that the control message 70 is a particular type of protocol X control message, in particular an X3 type protocol X control message (e.g., “X3 REQUEST”). The payload 74 also includes ICMP echo request quantity 76-2 that indicates that each device 12 in the path 26 of devices 12 is to send 5 ICMP echo requests to the next device 12 in the path 26 of devices 12 (e.g., “5 ICMP”). The payload 74 also includes information 76-3 that indicates what actions a device 12 in the path 26 of devices 12 should take in the event of an error (“ERR A”). The source device 12-S determines a future point in time, such as a point in time that is 500 milliseconds, 1 second, or the like, in the future, and inserts a timestamp that identifies the future point in time in information 76-4 in the payload 74. Each of the devices 12 may be time synchronized.

The source device 12-S then sends the control message 70 toward the destination device 12-D by sending the control message 70 to the intermediate device 12-I1 according to the network information maintained by the source device 12-S.

The intermediate device 12-I1 receives the control message 70 and recognizes, based on the control message identifier field 72-1 that the control message 70 is a “PROT. X” control message. The intermediate device 12-I1 accesses the payload 74 and determines, based on the information 76-1 that the control message 70 is an X3 type protocol X control message (e.g., “X3 REQUEST”). The intermediate device 12-I1 accesses the ICMP echo request quantity 76-2 and determines that 5 ICMP echo requests are to be sent to the next device 12 in the path 26 of devices 12. The intermediate device 12-I1 accesses the payload 74 and determines, based on the information 76-4, the particular future point in time at which the intermediate device 12-I1 should send the next device 12 in the path 26 of devices the 5 ICMP echo requests.

The intermediate device 12-I1 determines, based on layer 3 information maintained by the intermediate device 12-I1, that the intermediate device 12-I2 is the next device (e.g., the next hop) to which a message destined for the IP address identified in the destination address field 30-3 (10.151.11.17) is to be sent.

The intermediate device 12-I1 then sends the control message 70 toward the destination device 12-D by sending the control message 70 to the intermediate device 12-I2 according to the network information maintained by the source device 12-S.

The intermediate device 12-I2 receives the control message 70 and recognizes, based on the control message identifier field 72-1 that the control message 70 is a “PROT. X” control message. The intermediate device 12-I2 accesses the payload 74 and determines, based on the information 76-1 that the control message 70 is an X3 type protocol X control message (e.g., “X3 REQUEST”). The intermediate device 12-I2 accesses the ICMP echo request quantity 76-2 and determines that 5 ICMP echo requests are to be sent to the next device 12 in the path 26 of devices 12. The intermediate device 12-I2 accesses the payload 74 and determines, based on the information 76-4, the particular future point in time at which the intermediate device 12-I2 should send the next device 12 in the path 26 of devices the 5 ICMP echo requests.

The intermediate device 12-I2 determines that the destination device 12-D is on the same network as the intermediate device 12-I2 (via the network interface 22), and thus that the destination device 12-D is the next device 12 in the path 26 of devices 12. The intermediate device 12-I2 then sends the control message 70 to the destination device 12-D via the network interface 22.

At the future point in time identified in the information 76-4, the source device 12-S sends the intermediate device 12-I1 five ICMP echo requests, the intermediate device 12-I1 sends the intermediate device 12-I2 five ICMP echo requests, and the intermediate device 12-I1 sends the destination device 12-D five ICMP echo requests. Each of the devices 12 receives five ICMP echo reply messages, and stores the information as RTT information 78-1, 78-2 and 78-3, respectively.

The destination device 12-D receives the control message 70 and recognizes, based on the control message identifier field 72-1 that the control message 70 is a “PROT. X” control message. The destination device 12-D accesses the payload 74 and determines, based on the information 76-1 that the control message 70 is an X3 type protocol X control message (e.g., “X3 REQUEST”). The destination device 12-D accesses the destination address field 72-3 and determines that the control message 70 was addressed to the destination device 12-D. The destination device 12-D waits until the future point in time identified in the information 76-4, and a predetermined amount of time, such as 250 ms, 500 ms, a second, or the like, subsequent to such time and then generates a control message response 80, or, alternatively, generates the control message response 80 and waits until the future point in time and the predetermined amount of time. The control message response 80 includes a control message identifier field 82-1 that identifies the packet as a “PROT. X” control message. The control message response 80 has a source address field 82-2 that identifies the destination device 12-D as the originator of the control message response 80 and a destination address field 82-3 that identifies the source device 12-S as the destination of the control message response 80. The destination device 12-D generates a payload 84 that includes information 86-1 that identifies the control message response 80 as a X3 type control message response.

The destination device 12-D sends the control message response 80 toward the source device 12-S by sending the control message response 80 to the intermediate device 12-I2 according to the network information maintained by the destination device 12-D. The intermediate device 12-I2 receives the control message response 80 from the destination device 12-D and determines, based on the control message identifier field 82-1 and the information 86-1 that the control message response 80 is a control message response to the previously sent control message 70. The intermediate device 12-I2 determines, based on the information 86-1, that the control message response 80 is an X3 type control message response. The intermediate device 12-I2 accesses the previously stored RTT information 78-3 and modifies the payload 84 to include information 86-2 that identifies the IP addresses of the two devices between which the RTTs were determined (i.e., the intermediate device 12-I2 and the destination device 12-D), and information 86-3 that identifies the five RTTs.

Based on the destination address field 82-3, the intermediate device 12-I2 determines that the control message response 80 is destined for the source device 12-S. Based on network information maintained by the intermediate device 12-I2, the intermediate device 12-I2 determines that the intermediate device 12-I1 is the next device in a path of devices between the intermediate device 12-I2 and the source device 12-S and sends the control message response 80 to the intermediate device 12-I1.

The intermediate device 12-I1 receives the control message response 80 from the intermediate device 12-I2 and determines, based on the control message identifier field 82-1 and the information 86-1 that the control message response 80 is a control message response to the previously sent control message 70. The intermediate device 12-I1 determines, based on the information 86-1, that the control message response 80 is an X3 type control message response. The intermediate device 12-I1 accesses the previously stored RTT information 78-2 and modifies the payload 84 to include information 86-4 that identifies the IP addresses of the two devices between which the RTTs were determined (i.e., the intermediate device 12-I1 and the intermediate device 12-I2), and information 86-5 that identifies the five RTTs. Based on the destination address field 82-3, the intermediate device 12-I1 determines that the control message response 80 is destined for the source device 12-S. Based on network information maintained by the intermediate device 12-I1, the intermediate device 12-I1 determines that the intermediate device 12-I1 can send the control message response 80 directly to the source device 12-S. The intermediate device 12-I1 sends the control message response 80 directly to the source device 12-S.

The source device 12-S receives the control message response 80 from the intermediate device 12-I1 and determines, based on the control message identifier field 82-1 and the information 86-1 that the control message response 80 is a control message response to the previously sent control message 70. The source device 12-S determines, based on the information 86-1, that the control message response 80 is an X3 type control message response. The source device 12-S accesses the previously stored RTT information 78-1 that identifies the IP addresses of the two devices between which the RTTs were determined (i.e., the source device 12-S and the intermediate device 12-I1), and the five RTTs. The source device 12-S may then store such information as information 86-6 and 86-7 in the payload 84, and/or present the information contained in the payload 64 along with the previously stored RTT information 78-1 on the display device 44 in a manner similar that illustrated above with regard to FIG. 2.

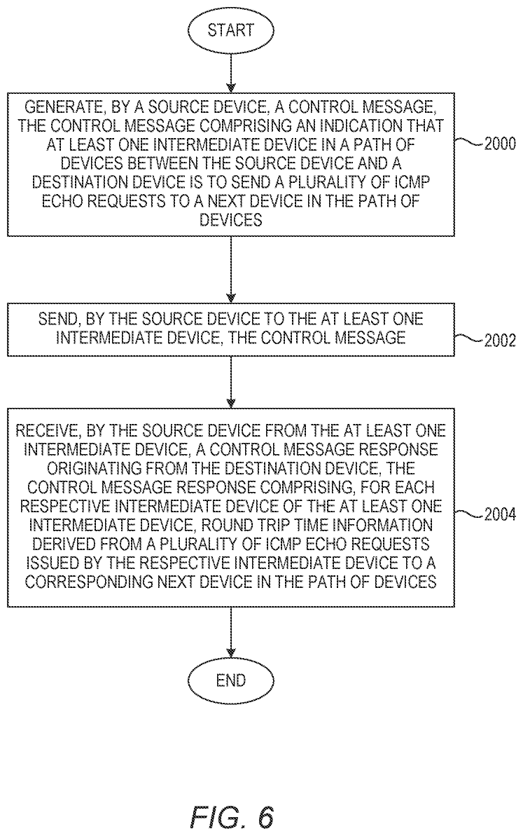

FIG. 6 is a flowchart of a method for determining round trip times between devices in a path of devices according to one embodiment. FIG. 6 will be discussed in conjunction with FIGS. 1, 4 and 5. The source device 12-S generates the control message 28, 52, or 70, the control message 28, 52, or 70 comprising an indication that at least one intermediate device 12 in the path 26 of devices 12 between the source device 12-S and the destination device 12-D is to send a plurality of ICMP echo requests to a next device 12 in the path 26 of devices 12 (block 2000). In some embodiments, even prior to generating the control message 28, 52, or 70, the source device 12-S may ensure that the destination device 12-D is on a different network than the source device 12-S, and if not, return an error message.

The source device 12-S sends, to the intermediate device 12-I1, the control message 28, 52, or 70 (block 2002). The source device 12-S receives, from the intermediate device 12-I1, the control message response 36, 60, 80 originating from the destination device 12-D, the control message response 36, 60, 80 comprising, for each respective intermediate device 12 of the at least one intermediate device 12, round trip time information derived from a plurality of ICMP echo requests issued by the respective intermediate device 12 to a corresponding next device 12 in the path 26 of devices 12 (block 2004). Individuals will recognize improvements and modifications to the preferred examples of the disclosure. All such improvements and modifications are considered within the scope of the concepts disclosed herein and the claims that follow.

What is claimed is:

1. A method comprising:
generating, by a source device, a control message, the control message comprising an indication that at least one intermediate device in a path of devices between the source device and a destination device is to send a plurality of ICMP echo requests to a next device in the path of devices;
sending, by the source device to the at least one intermediate device, the control message; and
receiving, by the source device from the at least one intermediate device, a control message response originating from the destination device, the control message response comprising, for each respective intermediate device of the at least one intermediate device, round trip time information derived from a plurality of ICMP echo requests issued by the respective intermediate device to a corresponding next device in the path of devices.

2. The method of claim 1 further comprising:
presenting, on a display device, based on the control message response, information associated with round trip times of packets between each respective intermediate device and the corresponding next device in the path of devices.

3. The method of claim 1 wherein the control message is propagated along the path of devices based on a layer 3 address of the destination device.

4. The method of claim 1 wherein each intermediate device comprises:
a first network interface associated with a first IP network; and
a second network interface associated with a second IP network.

5. The method of claim 1 wherein the control message includes an ICMP echo request quantity that identifies a number of ICMP echo requests to be sent by each intermediate device of the at least one intermediate device.

6. The method of claim 1 wherein the round trip time information comprises, for each respective intermediate device, a plurality of round-trip times determined based on the plurality of ICMP echo requests issued by the respective intermediate device to the next device in the path of devices.

7. The method of claim 1 wherein the round trip time information comprises, for each respective intermediate device, one of an average round trip time based on a plurality of ICMP echo reply messages received from the corresponding next device in the path of devices, a mean round trip time based on a plurality of ICMP echo reply messages received from the corresponding next device in the path of devices, and a mode round trip time based on a plurality of ICMP echo reply messages receive from the corresponding next device in the path of devices.

8. The method of claim 1 further comprising:
sending, by the source device to a first intermediate device of the at least one intermediate device, a plurality of ICMP echo requests; and
receiving, by the source device from the first intermediate device, a plurality of ICMP echo reply messages.

9. The method of claim 8 further comprising:
presenting, by the source device on a display device based on the control message response, round-trip time information that identifies, for each respective device in the path of devices other than the destination device, a round-trip time of a packet between the respective device and the next device.

10. The method of claim 1 further comprising:
receiving, by a first intermediate device of the at least one intermediate device, the control message;
sending, by the first intermediate device to a next device in the path of devices, a plurality of ICMP echo requests;
receiving, by the first intermediate device from the next device, a corresponding plurality of ICMP echo reply messages;
modifying the control message to include round trip time information based on the corresponding plurality of ICMP echo reply messages; and
sending the control message with the round trip time information to the next device.

11. The method of claim 1 further comprising:
receiving, by a first intermediate device of the at least one intermediate device, the control message;
sending, by the first intermediate device to a next device in the path of devices, the control message;
subsequent to sending the control message, sending, by the first intermediate device to the next device, a plurality of ICMP echo requests;
receiving, by the first intermediate device from the next device, a corresponding plurality of ICMP echo reply messages;
receiving, by the first intermediate device, a control message response originating from the destination device in response to the control message;
modifying the control message response to include round trip time information generated based on the corresponding plurality of ICMP echo reply messages to generate a modified control message response; and
sending, by the first intermediate device, the control message response toward the source device.

12. The method of claim 11 further comprising:
modifying the control message response to include a device identifier that indicates that the round trip time information identifies a round trip time between the first intermediate device and the next device.

13. The method of claim 1 further comprising:
receiving, by a first intermediate device of the at least one intermediate device, the control message;
sending, by the first intermediate device to a next device in the path of devices, the control message;
extracting, from the control message, a future point in time;
at the future point in time, initiating a plurality of ICMP echo requests to the next device;
receiving, by the first intermediate device from the next device, a corresponding plurality of ICMP echo reply messages;
receiving, by the first intermediate device, a control message response originating from the destination device in response to the control message, the control message response being addressed to the source device;
modifying the control message response to include round trip time information generated based on the corresponding plurality of ICMP echo reply messages to generate a modified control message response; and
sending, by the first intermediate device, the control message response toward the source device.

14. A source device, comprising:
a memory; and
a processor device coupled to the memory, the processor device configured to:
generate a control message, the control message comprising an indication that at least one intermediate device in a path of devices between the source device and a destination device is to send a plurality of ICMP echo requests to a next device in the path of devices;
send, to the at least one intermediate device, the control message; and
receive, from the at least one intermediate device, a control message response originating from the destination device, the control message response comprising, for each respective intermediate device of the at least one intermediate device, round trip time information derived from a plurality of ICMP echo requests issued by the respective intermediate device to a corresponding next device in the path of devices.

15. The source device of claim 14 wherein the control message includes an ICMP echo request quantity that identifies a number of ICMP echo requests to be sent by each intermediate device of the at least one intermediate device.

16. The source device of claim 14 wherein the round trip time information comprises, for each respective intermediate device, a plurality of round-trip times determined based on the plurality of ICMP echo requests issued by the respective intermediate device to the next device in the path of devices.

17. The source device of claim 14, wherein the processor device is further configured to:
send, to a first intermediate device of the at least one intermediate device, a plurality of ICMP echo requests; and
receive, from the first intermediate device, a plurality of ICMP echo reply messages from the first intermediate device.

18. A non-transitory computer-readable storage medium that includes executable instructions to cause a processor device to:
generate a control message, the control message comprising an indication that at least one intermediate device in a path of devices between a source device and a destination device is to send a plurality of ICMP echo requests to a next device in the path of devices;
send, to the at least one intermediate device, the control message; and
receive, from the at least one intermediate device, a control message response originating from the destination device, the control message response comprising, for each respective intermediate device of the at least one intermediate device, round trip time information derived from a plurality of ICMP echo requests issued by the respective intermediate device to a corresponding next device in the path of devices.

19. The non-transitory computer-readable storage medium of claim 18 wherein the control message includes an ICMP echo request quantity that identifies a number of ICMP echo requests to be sent by each intermediate device of the at least one intermediate device.

20. The non-transitory computer-readable storage medium of claim 18 wherein the round trip time information comprises, for each respective intermediate device, a plurality of round-trip times determined based on the plurality of ICMP echo requests issued by the respective intermediate device to the next device in the path of devices.
